(19) United States
(12) Patent Application Publication
(10) Pub. No.: US 2024/0370379 A1
(43) Pub. Date: Nov. 7, 2024

(54) MEMORY-BASED SYSTEM-LEVEL CACHE MANAGEMENT METHOD AND ASSOCIATED ELECTRONIC DEVICE

(71) Applicant: MEDIATEK INC., Hsin-chu (TW)

(72) Inventors: Chun-Ming Su, Hsinchu City (TW); Chih-Wei Hung, Hsinchu City (TW); Yi-Lun Lin, Hsinchu City (TW); Kun-Lung Chen, Hsinchu City (TW); Po-Han Wang, Hsinchu City (TW); Ming-Hung Hsieh, Hsinchu City (TW); Yun-Ching Li, Hsinchu City (TW)

(73) Assignee: MEDIATEK INC., Hsin-chu (TW)

(21) Appl. No.: 18/143,623

(22) Filed: May 5, 2023

(51) Int. Cl. G06F 12/126; G06F 12/1009

(52) U.S. Cl. CPC G06F 12/126; G06F 12/1009

(57) ABSTRACT

An electronic device includes a memory usage identification circuit and a system-level cache (SLC). The memory usage identification circuit obtains a memory usage indicator that depends on memory usage of a storage space allocated in a system memory at which memory access is requested by a physical address. The SLC includes a cache memory and a cache controller. The cache controller performs cache management upon the cache memory according to the physical address and the memory usage indicator.

### BACKGROUND

The present invention relates to cache management, and more particularly, to a memory-based system-level cache management method and an associated electronic apparatus.

The latency of moving data has greatly exceeded the latency of executing an instruction. Hence, caches, which reduce memory latency and reduce memory traffic, are important components of all modern electronic devices. For example, a mobile electronic device has multiple master devices, including a central processing unit (CPU), a graphic processing unit (GPU), a video decoder (VDEC), etc., that can share access to a system memory, such as a dynamic random access memory (DRAM), via an external memory interface (EMI). A system-level cache (SCL) can be located between the system memory and the master devices to reduce the number of times that the system memory is accessed by caching data requested by the master devices. Generally speaking, effectiveness of the SLC can be measured by the hit rate defined by S/R, where S is the number of memory requests serviced by the SLC, and R is the total number of memory requests made to the SLC. One of the methods of improving SLC's hit rate is to choose a good cache replacement policy. For example, a priority-based cache replacement policy may be employed for determining which cache line in a cache memory should be evicted to make space for the new data when the cache memory is full and a cache miss event occurs. If all memory requests generated from the same master device are treated as having the same priority, the priority-based cache replacement policy is not aware of the memory usage of the memory requests. However, it is possible that these memory requests issued from the same master device may contribute different impact to the SLC's hit rate due to different memory usage. Regarding some scenarios, treating all memory requests issued from the same master device as having the same cache replacement priority, without taking the actual memory usage into consideration, is unable to effectively improve SLC's hit rate.

### SUMMARY

One of the objectives of the claimed invention is to provide a memory-based system-level cache management method and an associated electronic apparatus.

According to a first aspect of the present invention, an exemplary electronic device is disclosed. The exemplary electronic device includes a memory usage identification circuit and a system-level cache (SLC). The memory usage identification circuit is arranged to obtain a memory usage indicator that depends on memory usage of a storage space allocated in a system memory at which memory access is requested by a physical address. The SLC includes a cache memory and a cache controller. The cache controller is arranged to perform cache management upon the cache memory according to the physical address and the memory usage indicator.

According to a second aspect of the present invention, an exemplary cache management method is disclosed. The exemplary cache management method includes: obtaining a memory usage indicator that depends on memory usage of a storage space allocated in a system memory at which memory access is requested by a physical address; and performing cache management upon a cache memory of a system-level cache (SLC) according to the physical address and the memory usage indicator.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a concept of a proposed memory-based SLC management design according to an embodiment of the present invention.

FIG. 2 is a diagram illustrating one implementation of the proposed memory-based SLC management design according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

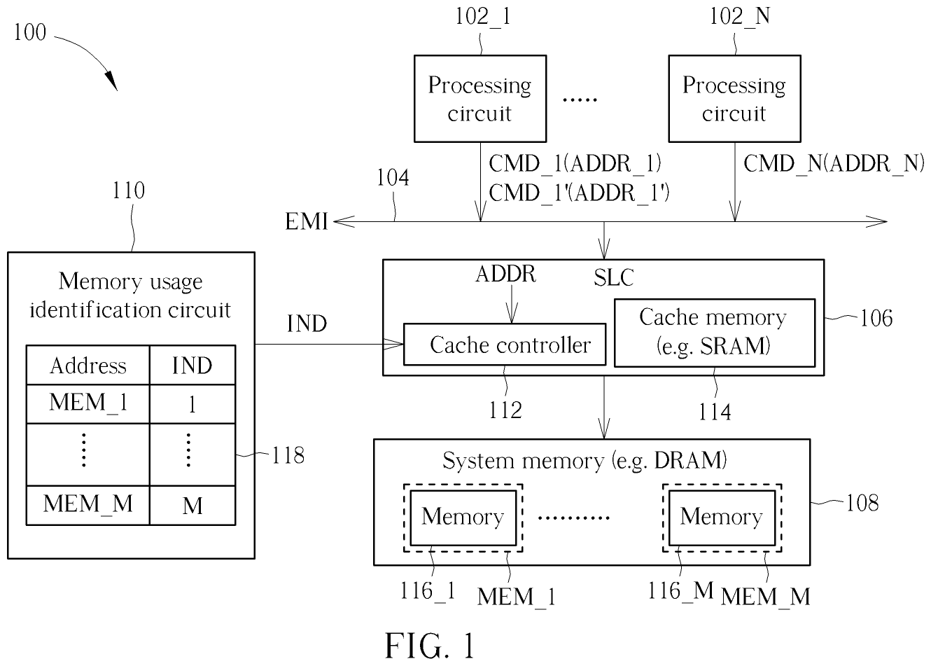

FIG. 1 is a diagram illustrating a concept of a proposed memory-based SLC management design according to an embodiment of the present invention. By way of example, but not limitation, an electronic device 100 that employs the proposed memory-based SLC management design may be a mobile electronic device such as a smartphone or a tablet. The electronic device 100 may include a plurality of processing circuits 102_1-102_N (N≥2), an external memory interface (EMI) 104, a system-level cache (SLC) 106, a system memory 108, and a memory usage identification circuit 110. It should be noted that only the components pertinent to the present invention are illustrated in FIG. 1. In practice, the electronic device 100 is allowed to include additional circuit components for other designed functions.

The processing circuits 102_1-102_N are master devices that may include processors and dedicated hardware. For example, the processing circuits 102_1-102_N include a central processing unit (CPU), a graphics processing unit (GPU), a video decoder (VDEC), etc. The system memory 108 may be an off-chip memory such as a dynamic random access memory (DRAM). The processing circuits 102_1-102_N may allocate a plurality of memories (or buffers) 116_1-116_M (M≥2) in the system memory 108 for different memory usage, where the memories 116_1-116_M are allocated in different storage spaces (e.g., contiguous physical address ranges) MEM_1-MEM_M, respectively. For example, the memories 116_1-116_M allocated in the system memory 108 may include an Android® memory, a real-time operating system (RTOS) memory, a bitstream buffer, a video work buffer, a video buffer, an inline racing buffer, a graphics buffer, etc. Each of the memories 116_1-116_M may be accessed by one or more of the processing circuits 102_1-102_N, depending upon its memory usage.

The SLC 106 is located between the processing circuits 102_1-102_N and the system memory 108, and is shared by the processing circuits 102_1-102_N through EMI 104. That is, memory requests issued from any of the processing circuits 102_1-102_N can be directly serviced by the SLC 106 when cache hit events occur. The SLC 106 includes a cache controller 112 and a cache memory 114. The cache memory 114 may be an on-chip memory such as a static random access memory (SRAM), and includes a plurality of cache lines each for storing cached data. The cache controller 112 is a hardware circuit capable of performing SLC management upon the cache memory 114 to deal with cache hit events and cache miss events.

In this embodiment, the memory usage identification circuit 110 obtains a memory usage indicator IND that depends on memory usage of a storage space allocated in the system memory 108 at which memory access (e.g., a DRAM read operation or a DRAM write operation) is requested by a physical address (e.g., a read address or a write address) ADDR, and the cache controller 112 performs the proposed memory-based SLC management (which include cache replacement) upon the cache memory 114 according to the physical address ADDR and the associated memory usage indicator IND. The memories 116_1-116_M are assigned with different memory usage indicators, respectively. For example, the memory usage identification circuit 110 may include a look-up table (LUT) 118 that records the mapping between memories 116_1-116_M and memory usage indicators. When the physical address ADDR is within a physical address range possessed by the storage space MEM_i (1≤i≤M), the memory usage indicator IND is set by i (i.e., IND=i) to indicate that memory access requested by the physical address ADDR is directed to the specific memory usage for which the memory 116_i is allocated in the system memory 108.

In general, the physical address ADDR is translated from a logical address (also known as a virtual address) generated from a processing circuit. For example, the processing circuit 102_1 generates a memory request CMD_1 with a logical address ADDR 1 for reading data from the logical address ADDR_1 or writing data into the logical address ADDR_1, and the processing circuit 102_N generates a memory request CMD_N with a logical address ADDR N for reading data from the logical address ADDR N or writing data into the logical address ADDR N. In a case where the physical address ADDR translated from the logical address ADDR_1 and the physical address ADDR translated from the logical address ADDR N are directed to the same memory usage (i.e., the same memory/buffer allocated in the system memory 108), the memory usage indicator IND associated with the physical address ADDR translated from the logical address ADDR_1 is the same as the memory usage indicator IND associated with the physical address ADDR translated from the logical address ADDR N. In another case where the physical address ADDR translated from the logical address ADDR_1 and the physical address ADDR translated from the logical address ADDR N are directed to different memory usage (i.e., different memories/buffers allocated in the system memory 108), the memory usage indicator IND associated with the physical address ADDR translated from the logical address ADDR_1 is different from the memory usage indicator IND associated with the physical address ADDR translated from the logical address ADDR N.

For another example, the processing circuit 102_1 generates one memory request CMD_1 with a logical address ADDR_1 for reading data from the logical address ADDR_1 or writing data into the logical address ADDR_1, and further generates another memory request CMD_1′ with a logical address ADDR_1′ for reading data from the logical address ADDR_1′ or writing data into the logical address ADDR_1′. In a case where the physical address ADDR translated from the logical address ADDR_1 and the physical address ADDR translated from the logical address ADDR_1′ are directed to the same memory usage (i.e., the same memory/buffer allocated in the system memory 108), the memory usage indicator IND associated with the physical address ADDR translated from the logical address ADDR_1 is the same as the memory usage indicator IND associated with the physical address ADDR translated from the logical address ADDR_1′. In another case where the physical address ADDR translated from the logical address ADDR_1 and the physical address ADDR translated from the logical address ADDR_1′ are directed to different memory usage (i.e., different memories/buffers allocated in the system memory 108), the memory usage indicator IND associated with the physical address ADDR translated from the logical address ADDR_1 is different from the memory usage indicator IND associated with the physical address ADDR translated from the logical address ADDR_1′.

To put it simply, the memory usage identification circuit 110 sets a value of the memory usage indicator IND associated with a memory request on the basis of memory usage of a memory that has the data requested by the memory request, regardless of a source of the memory request. The memory usage indicator IND may be set by any means to provide hint information that can be referenced by SLC cache replacement to determine whether to cache the data requested by the physical address (read/write address) ADDR in the cache memory 114. In some embodiments of the present invention, the look-up table 118 may be integrated into a page table that is stored in the system memory 108 and is used to deal with translation between logical addresses and physical addresses.

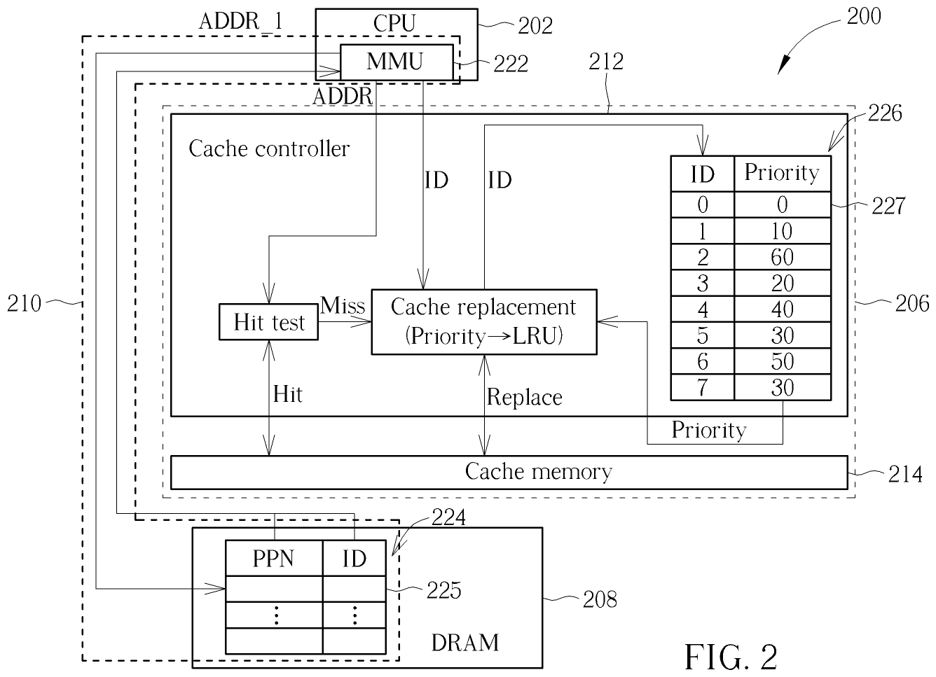

FIG. 2 is a diagram illustrating one implementation of the proposed memory-based SLC management design according to an embodiment of the present invention. The design of the electronic device 200 shown in FIG. 2 is based on the architecture shown in FIG. 1. Specifically, one of the processing circuits 102_1-102_N is implemented by a CPU 202, the SLC 106 is implemented by an SLC 206 including a cache controller 212 and a cache memory 214, the system memory 108 is implemented by a DRAM 208, and the memory usage identification circuit 110 is implemented by a memory usage identification circuit 210 including a memory management unit (MMU) 222 and a page table 224. The page table 224 includes a plurality of page table entries 225 for storing mapping between logical addresses and physical addresses. For example, a portion of a logical address ADDR_1 generated by the CPU 202 acts as an index value of a page table entry, a physical page number (PPN) recorded in the page table entry 225 pointed to by the portion of the logical address ADDR_1 is obtained by the MMU 222, and the MMU 222 combines the obtained PPN and a page offset value (which is another portion of the logical address ADDR_1) to generate the physical address ADDR that is mapped to the logical address ADDR_1. In this embodiment, the page table entries 225 of the page table 224 are further arranged to store a plurality of identifiers (IDs), respectively, where the ID values act as memory usage indicators. Hence, regarding physical pages belonging to the same memory/buffer allocated in the DRAM 208, the same ID value is recorded in the page table entries 225 with PPNs of these physical pages. For example, the DRAM 208 may have an Android® memory, an RTOS memory, a bitstream buffer, a video work buffer, a video buffer, an inline racing buffer, and a graphics buffer. The page table 224 may record ID value=1 in any page table entry 225 with a recorded PPN of a physical page belonging to the Android® memory, record ID value=2 in any page table entry 225 with a recorded PPN of a physical page belonging to the RTOS memory, record ID value=3 in any page table entry 225 with a recorded PPN of a physical page belonging to the bitstream buffer, record ID value=4 in any page table entry 225 with a recorded PPN of a physical page belonging to the video work buffer, record ID value=5 in any page table entry 225 with a recorded PPN of a physical page belonging to the video buffer, record ID value=6 in any page table entry 225 with a recorded PPN of a physical page belonging to the inline racing buffer, and record ID value=7 in any page table entry 225 with a recorded PPN of a physical page belonging to the graphics buffer.

As mentioned above, the MMU 222 receives the logical address ADDR_1 generated from the CPU 202, and determines the physical address ADDR and the identifier ID (which acts as a memory usage indicator) according to a target page table entry 225 selected from the page table 224 in response to the logical address ADDR_1. The physical address ADDR and the identifier ID (which acts as a memory usage indicator) are both provided to the SLC 206 (particularly, cache controller 212 of SLC 206). The cache controller 212 performs a hit test according to the physical address ADDR. When a cache hit event occurs, it means that the data requested by the physical address (read/write address) ADDR is cached in the cache memory 214. When a cache miss event occurs, it means that the data requested by the physical address (read/write address) ADDR is not cached in the cache memory 214, and the memory request has to be serviced by the DRAM 208. In addition, when a cache miss event occurs, the cache controller 212 enables cache replacement to determine whether to cache the data requested by the physical address (read/write address) ADDR in the cache memory 214. Specifically, when the cache controller 212 detects that data requested by the physical address (read/write address) ADDR is not available in the cache memory 214, the cache controller 212 locates the data requested by the physical address (read/write address) ADDR from the DRAM 208, and performs cache replacement upon the cache memory 214 according to the identifier ID (which acts as a memory usage indicator) associated with the data requested by the physical address (read/write address) ADDR.

In this embodiment, the cache replacement employs a priority-based cache replacement policy. Hence, the cache controller 212 includes a cache policy table 226 having a plurality of table entries 227 for storing mapping between identifiers (which act as memory usage indicators) and priority values. The cache controller 212 determines a priority value mapped to the identifier ID (which is associated with the data requested by the physical address (read/write address) ADDR) according to the cache policy table 226, and refers to the priority-based cache replacement policy to determine whether to cache the data requested by the physical address (read/write address) ADDR in the cache memory 214. For example, among cache lines with lower priorities in the cache memory 214 that is full, lower-priority data stored in a least recently used (LRU) cache line is replaced with the higher-priority data requested by the physical address (read/write address) ADDR. However, this is for illustrative purposes only, and is not meant to be a limitation of the present invention. In practice, any SLC management design using a memory usage indicator (which depends on memory usage of a storage space allocated in a system memory at which memory access is requested by a physical address) for cache replacement falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device comprising:
a memory usage identification circuit, arranged to obtain a memory usage indicator that depends on memory usage of a storage space allocated in a system memory at which memory access is requested by a physical address; and
a system-level cache (SLC), comprising:
a cache memory; and
a cache controller, arranged to perform cache management upon the cache memory according to the physical address and the memory usage indicator.

2. The electronic device of claim 1, wherein the system memory has a plurality of memories allocated for different memory usage; and
the plurality of memories are assigned with different memory usage indicators, respectively.

3. The electronic device of claim 1, wherein the memory usage identification circuit comprises:
a page table, comprising a plurality of page table entries for storing mapping between logical addresses and physical addresses, wherein the plurality of page table entries are further arranged to store a plurality of memory usage indicators, respectively; and
a memory management unit (MMU), arranged to receive a logical address generated from a processing circuit, and determine the physical address and the memory usage indicator according to a target page table entry selected from the page table in response to the logical address.

4. The electronic device of claim 1, wherein when the cache controller detects that data requested by the physical address is not available in the cache memory, the cache controller locates the data requested by the physical address from the system memory, and performs cache replacement upon the cache memory according to the memory usage indicator associated with the data requested by the physical address.

5. The electronic device of claim 4, wherein the cache replacement employs a priority-based cache replacement policy; the cache controller comprises:
a cache policy table, comprising a plurality of table entries for storing mapping between memory usage indicators and priority values;
the cache controller determines a priority value mapped to the memory usage indicator according to the cache policy table, and refers to the priority-based cache replacement policy to determine whether to cache the data requested by the physical address in the cache memory.

6. The electronic device of claim 1, wherein the memory usage identification circuit is further arranged to obtain another memory usage indicator that is different from the memory usage indicator and depends on another memory usage of another storage space allocated in the system memory at which memory access is requested by another physical address; the physical address and said another physical address are derived from different logical addresses generated from a same processing circuit; and the cache controller is further arranged to perform the cache management upon the cache memory according to said another physical address and said another memory usage indicator.

7. A cache management method comprising:
obtaining a memory usage indicator that depends on memory usage of a storage space allocated in a system memory at which memory access is requested by a physical address; and
performing cache management upon a cache memory of a system-level cache (SLC) according to the physical address and the memory usage indicator.

8. The cache management method of claim 7, wherein the system memory has a plurality of memories allocated for different memory usage; and the plurality of memories are assigned with different memory usage indicators, respectively.

9. The cache management method of claim 7, wherein obtaining the memory usage indicator comprises:
receiving a logical address generated from a processing circuit; and
determining the physical address and the memory usage indicator according to a target page table entry selected from a page table in response to the logical address, wherein the page table comprises a plurality of page table entries for storing mapping between logical addresses and physical addresses, and the plurality of page table entries are further arranged to store a plurality of memory usage indicators, respectively.

10. The cache management method of claim 7, wherein performing the cache management upon the cache memory of the SLC comprises:
in response to detecting that data requested by the physical address is not available in the cache memory:
locating the data requested by the physical address from the system memory; and
performing cache replacement upon the cache memory according to the memory usage indicator associated with the data requested by the physical address.

11. The cache management method of claim 10, wherein the cache replacement employs a priority-based cache replacement policy; and
performing the cache replacement upon the cache memory comprises:
determining a priority value mapped to the memory usage indicator according to a cache policy table, wherein the cache controller comprises:
a cache policy table, comprising a plurality of table entries for storing mapping between memory usage indicators and priority values; and
referring to the priority-based cache replacement policy to determine whether to cache the data requested by the physical address in the cache memory.

12. The cache management method of claim 7, further comprising:
obtaining another memory usage indicator that is different from the memory usage indicator and depends on another memory usage of another storage space allocated in the system memory at which memory access is requested by another physical address, wherein the physical address and said another physical address are derived from different logical addresses generated from a same processing circuit; and
performing the cache management upon the cache memory of the SLC according to said another physical address and said another memory usage indicator.
